(19) United States
(12) Patent Application Publication
(10) Pub. No.: US 2020/0360221 A1
(43) Pub. Date: Nov. 19, 2020

(54) BODY CLEANING DEVICE

(71) Applicant: LIFETRONS SWITZERLAND HOLDINGS LIMITED, Tuen Mun (HK)

(72) Inventor: Chih-Ming TSENG, Tuen Mun (HK)

(21) Appl. No.: 16/733,031

(22) Filed: Jan. 2, 2020

(30) Foreign Application Priority Data
May 15, 2019 (EP) 19174772.4

(51) Int. Cl. A61H 7/00

(52) U.S. Cl. CPC A61H 7/005; A46B 13/02

(57) ABSTRACT

A body cleaning device is disclosed. The body cleaning device comprises a body cleaning assembly, a head massage assembly, and a facial cleaning assembly. The facial cleaning assembly can accommodate in an accommodating space which is formed by the body cleaning assembly and the head massage assembly. The body cleaning assembly is provided with a plurality of silicon brushes over a helmet thereon. The head massage assembly is provided with a plurality of protruding cylinders on a upper cover thereon. The facial cleaning assembly is provided with a plurality of facial silicon brushes over its surface. The body cleaning device can deep clean a body and a face by vibrating.

### FIELD OF THE INVENTION

The present invention relates to a body cleaning device, and particularly relates to a portably waterproof body cleaning device for cleaning a human body.

### BACKGROUND OF THE INVENTION

When we looked for a cleaning device for cleaning a human body, we found that merchandise of the cleaning device almost has only one function at present. For example, there might merely be merchandise for cleaning the human body but unsuitable for cleaning a face. Hence, it is inconvenient for consumers to buy or carry other merchandise for cleaning the face when they want to clean the face.

Moreover speaking of a subject about a size of the cleaning device, the more functions it has, the larger the size of the cleaning device is. When manufacturers devote to design the cleaning device with more than one function, they eventually meet inevitable problem with ponderous size.

Considering factors aforementioned, it is necessary for current market to have designs that to avoid ponderous size and to improve the portability and to take easy to carry. Moreover, these designs are expected to increase functional variety for use.

### SUMMARY OF THE INVENTION

According to aforementioned, an objective of the present invention is to provide a body cleaning device comprising a body cleaning assembly formed by a helmet and a lower cover, a head massage assembly formed by a groove and an upper cover, and a facial cleaning assembly. In the body cleaning assembly, a surface of the helmet includes a plurality of silicon brushes perpendicular to thereon; the lower cover includes a plurality of first magnetic components. In the head massage assembly, the groove is engaged with the upper cover, the groove includes a skirt body and a bottom portion, the skirt body surrounds the upper cover and engages with the upper cover, the bottom portion of the groove is provided with a plurality of protruding cylinders, the upper cover is provided with a plurality of second magnetic components, so that the body cleaning assembly is assembled with the head massage assembly by the plurality of first magnetic components and the plurality of second magnetic components. In the facial cleaning assembly, a surface of the facial cleaning assembly is provided with a plurality of facial silicon brushes, the facial cleaning assembly can accommodate in an accommodating space which is formed by the helmet of the body cleaning assembly and the groove of the head massage assembly.

According to above objectives, the body cleaning device can help to deep clean dirty of a user's skin and can fulfill multifunction owing to vibration effect attributed to the motors. Then, the body cleaning device is waterproof and portable so that the user can take easy to carry and use.

### BRIEF DESCRIPTION OF THE DRAWINGS

FIG. 1A is an exploded drawing of illustrating a body cleaning device in accordance with the present invention.

FIG. 1B is a perspective drawing of illustrating a body cleaning device in accordance with the present invention.

FIG. 2A is a perspective drawing of illustrating a body cleaning assembly in accordance with the present invention.

FIG. 2B is an exploded drawing of illustrating a body cleaning assembly in accordance with the present invention.

FIG. 3A is a perspective drawing of illustrating a head massage assembly in accordance with the present invention.

FIG. 3B is an exploded drawing of illustrating a head massage assembly in accordance with the present invention.

FIG. 4A is a perspective drawing of illustrating a facial cleaning assembly in accordance with the present invention.

FIG. 4B is an exploded drawing of illustrating a facial cleaning assembly in accordance with the present invention.

FIG. 5 is a rear plan view of illustrating a facial cleaning assembly in accordance with the present invention.

### DETAILED DESCRIPTION OF THE PREFERRED EMBODIMENT

In order to let one of skilled in the art sufficiently understand the technical contents of a body cleaning device of the present invention, relative embodiments and essential components are provided to illustrate the present invention. However, essential components of body cleaning device in following embodiments do not limit the present invention.

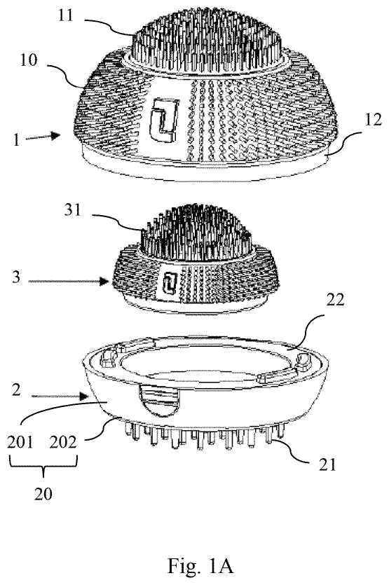

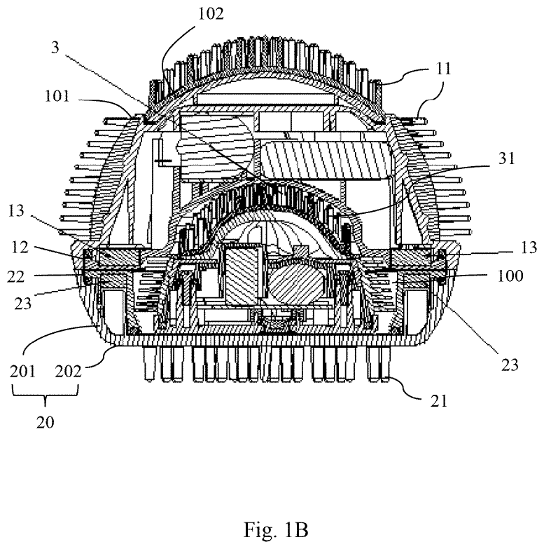

FIG. 1A is an exploded drawing of illustrating a body cleaning device in accordance with the present invention. FIG. 1B is a perspective drawing of illustrating a body cleaning device in accordance with the present invention. As shown in FIG. 1A and FIG. 1B, a body cleaning device comprising a body cleaning assembly 1, a head massage assembly 2, and a facial cleaning assembly 3. The body cleaning assembly 1 is formed by a helmet 10 and a lower cover 12. Wherein a surface of the helmet 10 includes a plurality of silicon brushes 11 perpendicular thereon, and the lower cover 12 is configured to a ring shape and include a plurality of first magnetic components 13 mounted thereon. The body cleaning assembly 1 can clean an entire human body without any blind spot owing to their 3D stereoscopic structure.

The head massage assembly 2 is formed by a groove 20 and an upper cover 22. The groove 20 is engaged with the upper cover 22. The groove 20 includes a skirt body 201 and a bottom portion 202. Wherein, the skirt body 201 surrounds the upper cover 22 and engages with the upper cover 22 and the bottom portion 202 of the groove 22 is provided with a plurality of protruding cylinders 21. The upper cover 22 is configured to a circle disk and include a plurality of second magnetic components 23 attracted by a plurality of first magnetic components 13 of the body cleaning assembly 1 in order to joint the body cleaning assembly 1 and the head massage assembly 2.

A surface of the facial cleaning assembly 3 is provided with a plurality of facial silicon brushes 31, and the facial cleaning assembly 3 can accommodate in an accommodating space 100 which is formed by the helmet 10 of the body cleaning assembly 1 and the groove 20 of the head massage assembly 2. The facial cleaning assembly 3 can clean a face overall without any blind spot owing to their 3D stereoscopic structure.

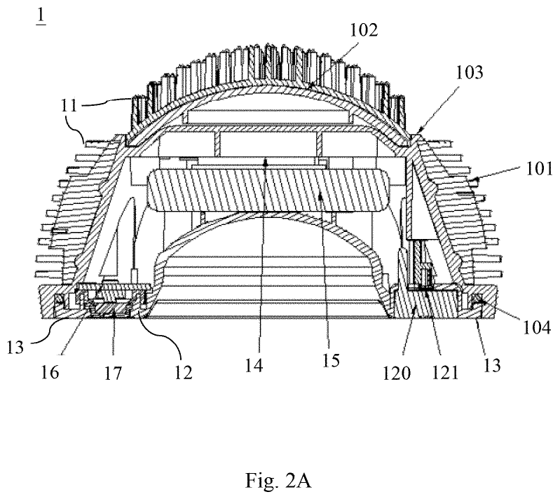

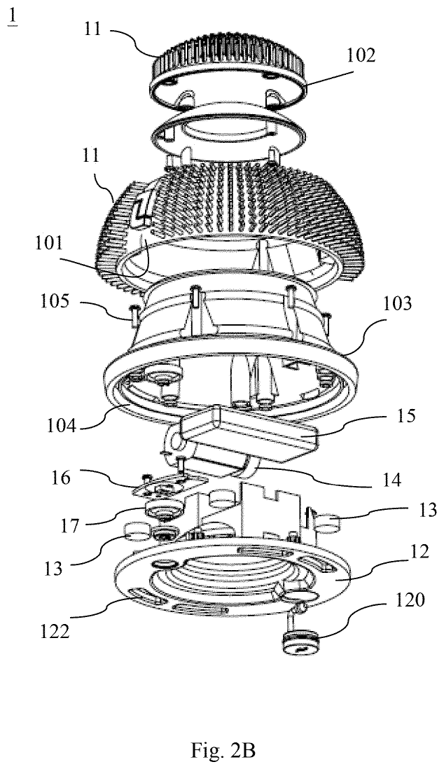

Then please refer to FIG. 2A and FIG. 2B. FIG. 2A is a perspective drawing of illustrating a body cleaning assembly in accordance with the present invention. FIG. 2B is an exploded drawing of illustrating a body cleaning assembly in accordance with the present invention. As shown in FIG. 2A and FIG. 2B, the helmet 10 of the body cleaning assembly 1 is formed by screwing a house 101 and a top portion 102, and the house 101 is surrounded the lower cover 12 and screwed with the lower cover 12 by the plurality of first screws 105. The plurality of silicon brushes 11 is disposed over a surface of the house 101 and the top portion 102. Specifically, the helmet 10 and the plurality of silicon brushes 11 arranged thereon are plasticized in whole with silica gel. The plurality of silicon brushes 11 is designed 3D symmetrically with the same or different height each other where the present invention doesn't limit to. Hence, the plurality of silicon brushes 11 is elastic to fit the user's body curve.

The helmet 10 is provided with a first lining 103 inside screwed with the lower cover 12 by interposing a first waterproof gasket 104 between the first lining 103 and the lower cover 12. The lower cover 12 is provided with a first USB waterproof cover 120, and the bottom of the first USB waterproof cover 120 is provided with a first USB charging element 121 electrically connected to a first motor 14. The first motor 14 is powered by a first battery 15 which is charged by the first USB charging element 121 when the first battery 15 is dead. For example, the first motor 14 can provide 10000 rpm or more rotating velocity. The first motor 14 is electrically connected to a first motherboard 16 and a first button 17 mounted on the first motherboard 16. The first motor 14, the first battery 15, the first USB charging element 121, first motherboard 16 and a first button 17 constitute a drive module which can drive the body cleaning device to vibrate so that the body cleaning assembly 1 can deeply clean a user's body by vibrating.

The first button 17 includes one key mounted on the lower cover 12 is a switch to turn on/turn off the first motor 14. Once the user press the first button 17, the body cleaning assembly 1 begins to vibrate. Then, the body cleaning assembly 1 stops vibrating when the user presses the first button 17 again. In one embodiment, the first button 17 connected to a lamp (not illustrated in the drawings). When the first battery 105 is exhausted, a color of a lamp will change form blue to red.

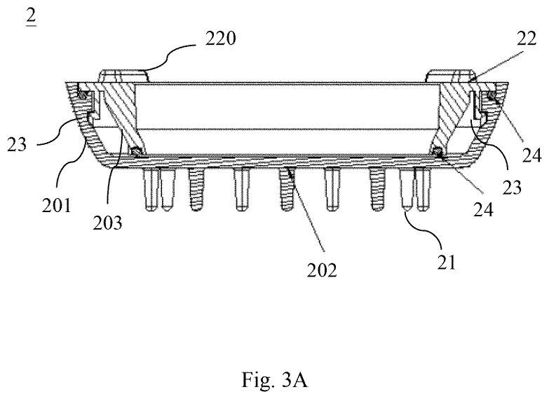

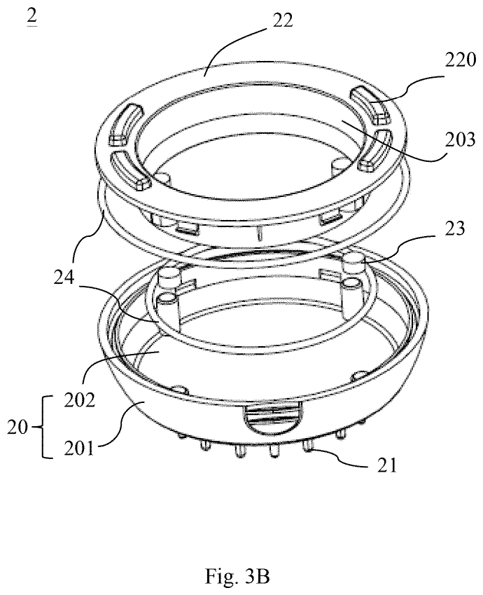

Then please refer to FIG. 3A and FIG. 3B. FIG. 3A is a perspective drawing of illustrating a head massage assembly in accordance with the present invention. FIG. 3B is an exploded drawing of illustrating a head massage assembly in accordance with the present invention. As shown in FIG. 3A and FIG. 3B, the upper cover 22 of the head massage assembly 2 is configured to a ring shape and provided with four plugs 220 mounted thereon. Four plugs 220 are engaged with corresponding four trenches 122 on the lower cover 12 of the body cleaning assembly 1. In addition, the upper cover 22 is provided with the plurality of second magnetic components 23, so that the body cleaning assembly 1 is assembled with the head massage assembly 2 by attraction between the plurality of first magnetic components 13 and the plurality of second magnetic components 23. Thereby the accommodating space 100 is formed between the body cleaning assembly 1 and the head massage assembly 2 for accommodating the facial cleaning assembly 3. A waterproof gasket 24 is engaged between the skirt body 201 and the upper cover 22 of the head massage assembly 2, and another waterproof gasket 24 is engaged between the bottom portion 202 and the inner well 203 of the head massage assembly 2 in order to encapsulate waterproof. The drive module can drive the head massage assembly 2 to vibrate so that the plurality of protruding cylinders 21 on the bottom portion 202 can massage the user's scalp by vibrating to promote blood circulation effectively.

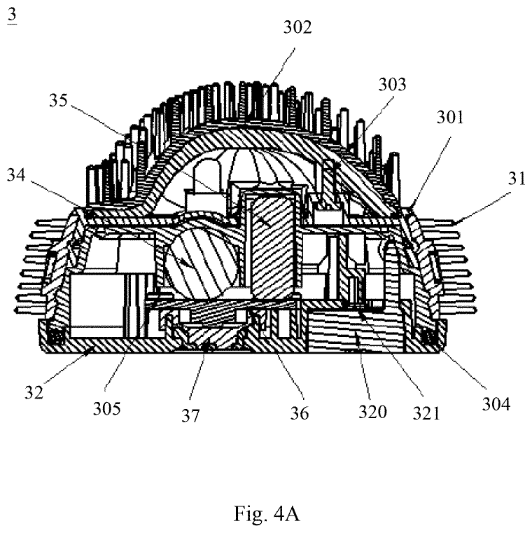

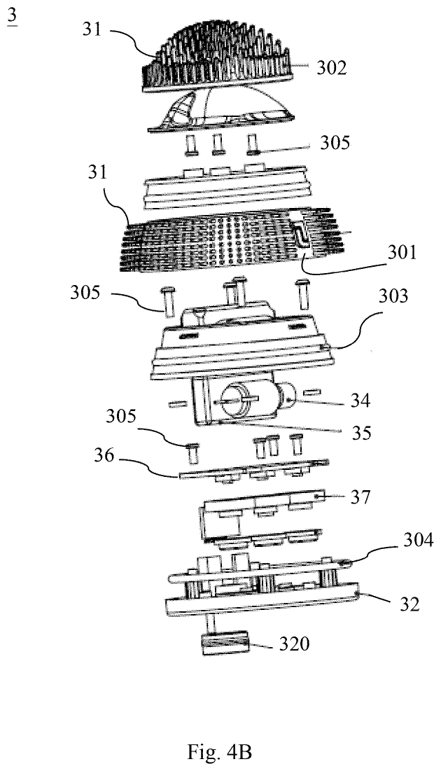

Then please refer to FIG. 4A and FIG. 4B. FIG. 4A is a perspective drawing of illustrating a facial cleaning assembly in accordance with the present invention. FIG. 4B is an exploded drawing of illustrating a facial cleaning assembly in accordance with the present invention. As shown in FIG. 4A and FIG. 4B, the facial cleaning assembly 3 is formed by screwing a hat body 30 and a bottom cover 32. Wherein, the hat body 30 is formed by screwing an edge portion 301 and a cap 302, the edge portion 301 is surrounded the bottom cover 32 and is screwed with the bottom cover 32 by the plurality of second screws 305. The plurality of facial silicon brushes 31 is disposed over a surface of the edge portion 301 and the cap 302. In one embodiment, the plurality of facial silicon brushes 31 on the surface of the cap 302 is designed as a 3D wave with different height to fit the facial contour of human. The effect to deep clean dirty hidden in pores of the face is attainable. Specifically, the hat body 30 and the plurality of facial silicon brushes 31 arranged thereon are plasticized in whole with silica gel. Hence, the plurality of facial silicon brushes 31 is elastic to fit the user's facial curve.

The hat body 30 is provided with a second lining 303 inside screwed with the bottom cover 32 by interposing a third waterproof gasket 304 between the second lining 303 and the bottom cover 32. The bottom cover 32 is provided with a second USB waterproof cover 320, and the bottom of the second USB waterproof cover 320 is provided with a second USB charging element 321 electrically connected to a second motor 34. The second motor 34 is powered by a second battery 35 which is charged by the second USB charging element 321 when the second battery 35 is dead. For example, the second motor 34 can provide 10000 rpm or more rotating velocity. The second motor 34 is electrically connected to a second motherboard 36 and a second button 37 mounted on the second motherboard 36. The second motor 34, the second battery 35, the second USB charging element 321, second motherboard 36 and a second button 37 constitute a drive module which can drive the facial cleaning assembly 3 to vibrate so that the facial cleaning assembly 3 can deep clean the user's face by vibrating.

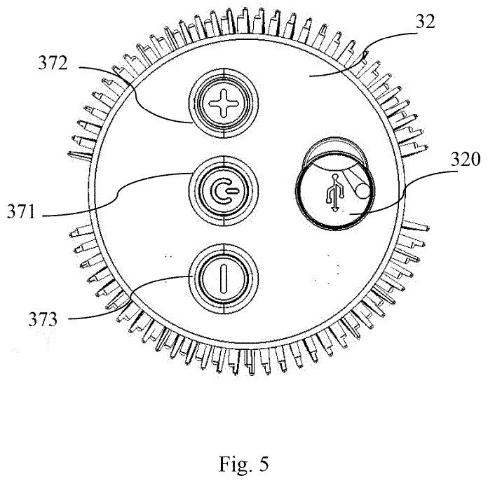

FIG. 5 is a rear plan view of illustrating a facial cleaning assembly in accordance with the present invention. As shown in FIG. 5, the second button 37 mounted on the bottom cover 32 comprises three keys containing a second switch 371 to turn on/turn off the second motor 34, a plus key 372 to increase vibrating strength, and a minus key 373 to decrease vibrating strength. Once the user press the second switch 371, the facial cleaning assembly 3 begins to vibrate. Then, the facial cleaning assembly 3 stops vibrating when the user presses the second switch 371 again. During vibration, the user can choose to press the plus key 372 or the minus key 373 to adjust vibrating strength. In one embodiment, the second button 37 connected to a lamp (not illustrated in the drawings). When the second battery 35 is exhausted, a color of a lamp will change form blue to red.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A body cleaning device, comprising:
a body cleaning assembly, the body cleaning assembly is formed by a helmet and a lower cover, a surface of the helmet includes a plurality of silicon brushes perpendicular to thereon, the lower cover includes a plurality of first magnetic components;
a head massage assembly, the head massage assembly is formed by a groove and an upper cover, the groove is engaged with the upper cover, the groove includes a skirt body and a bottom portion, the skirt body surrounds the upper cover and engages with the upper cover, the bottom portion of the groove is provided with a plurality of protruding cylinders, the upper cover is provided with a plurality of second magnetic components, so that the body cleaning assembly is assembled with the head massage assembly by the plurality of first magnetic components and the plurality of second magnetic components; and
a facial cleaning assembly, a surface of the facial cleaning assembly is provided with a plurality of facial silicon brushes, the facial cleaning assembly accommodate in an accommodating space which is formed by the helmet of the body cleaning assembly and the groove of the head massage assembly.

2. The body cleaning device according to claim 1, wherein the helmet is formed by screwing a house and a top portion, and the house is surrounded the lower cover and is screwed with the lower cover.

3. The body cleaning device according to claim 1, wherein a first waterproof gasket is screwed between the house and the lower cover of the body cleaning assembly.

4. The body cleaning device according to claim 1, wherein a second waterproof gasket is engaged between the skirt body and the upper cover of the head massage assembly.

5. The body cleaning device according to claim 1, wherein the helmet of the body cleaning assembly is provided for accommodating a first drive module including a first motherboard, a first battery and a first motor, and a first button.

6. The body cleaning device according to claim 1, wherein the lower cover of the body cleaning assembly is provided with a first USB waterproof cover and the bottom of the first USB waterproof cover is provided with a first USB charging element.

7. The body cleaning device according to claim 1, wherein the facial cleaning assembly is formed by screwing a hat body and a bottom cover, the hat body is formed by screwing an edge portion and a cap, the edge portion is surrounded the bottom cover and is screwed with the bottom cover, and a plurality of silicon brushes are disposed over a surface of the edge portion and the cap.

8. The body cleaning device according to claim 7, wherein the hat body of the facial cleaning assembly is provided for accommodating a second drive module including a second motherboard, a second battery and a second motor, and a second button.

9. The body cleaning device according to claim 7, wherein the bottom cover of the facial cleaning assembly is provided with a second USB waterproof cover and a bottom of the second USB waterproof cover is provided a second USB charging element.
